(19) United States
(12) Patent Application Publication
(10) Pub. No.: US 2007/0240040 A1
(43) Pub. Date: Oct. 11, 2007

(54) Non-compiled portable algorithm

(76) Inventors: Christopher Peters, Austin, TX (US); Sean-Marc Castruita, Round Rock, TX (US); John Landry, Austin, TX (US)

Correspondence Address: HAMILTON & TERRILE, LLP, P.O. BOX 203518, AUSTIN, TX, 78720, US

(21) Appl. No.: 11/398,001

(22) Filed: Apr. 5, 2006

(51) Int. Cl. G06F 15/00

(52) U.S. Cl. 715/522; 715/523

(57) ABSTRACT

A method of sharing logic, such as algorithms, is provided which uses an extensible stylesheet language (XSL) standard as a medium for implementing a distributable algorithm. Using the XSL standard to distribute the shared logic, provides the portability of the XML standard while removing the dependence of the individuals on a specific programming language for processing. Each entity can write an application that receives inputs and provides outputs in a consistent format regardless of the implementation of the XSL.

### BACKGROUND OF THE INVENTION

1. Field of the Invention

The present invention relates to sharing algorithms among entities and, more particularly, to sharing non-compiled portable algorithms among entities.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One function of information handling systems is electronically sharing information. One method of sharing information is via an open standard such as the extensible markup language (XML) standard. The XML standard provides a method for defining data elements on a web page and business to business documents. The XML standard provides for a tag structure similar to a hypertext markup language (HTML) structure; however, whereas HTML defines how elements are displayed, XML defines what those elements contain. With the gaining acceptance of the XML standard, it is becoming easier to share data between businesses. Once a common data model is decided and represented with XML, then each of the businesses can write XML interpreters to process the shared XML data in a fashion applicable to their individual business needs.

A method of sharing XML documents is by describing a style sheet for the XML document using the extensible stylesheet Language (XSL) standard. An XSL document includes three components, an XSL transformations component (XSLT), an XML Path Language (Xpath) component and an XSL Formatting Objects (XSL FO) component. The XSLT component is the processing language for the XSL standard and is used to convert XML documents into a document such as an HTML, portable document format (PDF), postscript (PS), Plain Text or another XML type document. The Xpath component identifies and selects tagged elements within an XML document. The XSL FO component provides the formal vocabulary for the XML document.

Sharing logic or instructions between businesses is more complicated. In most cases, logic is shared through documentation while source code is kept proprietary. This approach burdens each business with the responsibility of maintenance and does not guarantee that the intended behavior will be implemented. Another approach to ensure behavior is to share the source code that contains an implementation of the logic. However, this approach binds each business to the specific programming language or languages of the source code written by the provider. Even though the intended behavior of the logic will be implemented correctly, each business must now recompile their respective applications to work with the new code every time the source code is distributed.

Accordingly, it would be desirable to provide a method in which logic can be easily electronically shared.

### SUMMARY OF THE INVENTION

In accordance with the present invention, a method of sharing logic, such as algorithms, is provided which uses an extensible stylesheet language (XSL) standard as a medium for implementing a distributable algorithm. While the XSL standard is typically intended to transform data from one format to another (i.e. an XML document to a HTML document), using the XSL standard to distribute the shared logic, provides the portability of the XML standard while removing the dependence of the individuals on a specific programming language for processing. Each entity can write an application that receives inputs and provides outputs in a consistent format regardless of the implementation of the XSL. Now, all consumers of the shared logic are guaranteed the intended behavior of the algorithm and the distributor of the algorithm is the only point of contact for maintenance.

In one embodiment, the invention relates to a method for sharing logic among a plurality of entities. The method includes storing the logic using an extensible stylesheet language (XSL) standard as an XSL logic document; distributing the XSL logic document to a plurality of entities; and, importing the XSL logic document into software applications of respective entities of the plurality of entities. The software applications are independent of the XSL logic document and each software application includes a transform portion for translating the XSL logic document into a language of the software application.

In another embodiment, the invention relates to an apparatus for sharing logic among a plurality of entities. The apparatus includes means for storing the logic using an extensible stylesheet language (XSL) standard as an XSL logic document; means for distributing the XSL logic document to a plurality of entities, and means for importing the XSL logic document into software applications of respective entities of the plurality of entities. The software applications are independent of the XSL logic document and each software application includes a transform portion for translating the XSL logic document into a language of the software application.

In another embodiment, the invention relates to an information handling system which includes a processor and memory coupled to the processor. The memory stores a software application. The software application receiving an XSL logic document and is independent of the XSL logic document. The software application includes a transform portion for translating the XSL logic document into a language of the software application.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an environment which includes a portable algorithm.

FIG. 2 shows a flow chart of the operation of the method for providing a portable algorithm.

FIG. 3 shows a system block diagram of an information handling system.

FIG. 4 shows an example of a system which uses the method for providing a portable algorithm.

FIG. 5 shows a block diagram of the operation of the example system.

FIG. 6 shows another block diagram of the operation of the example system.

### DETAILED DESCRIPTION

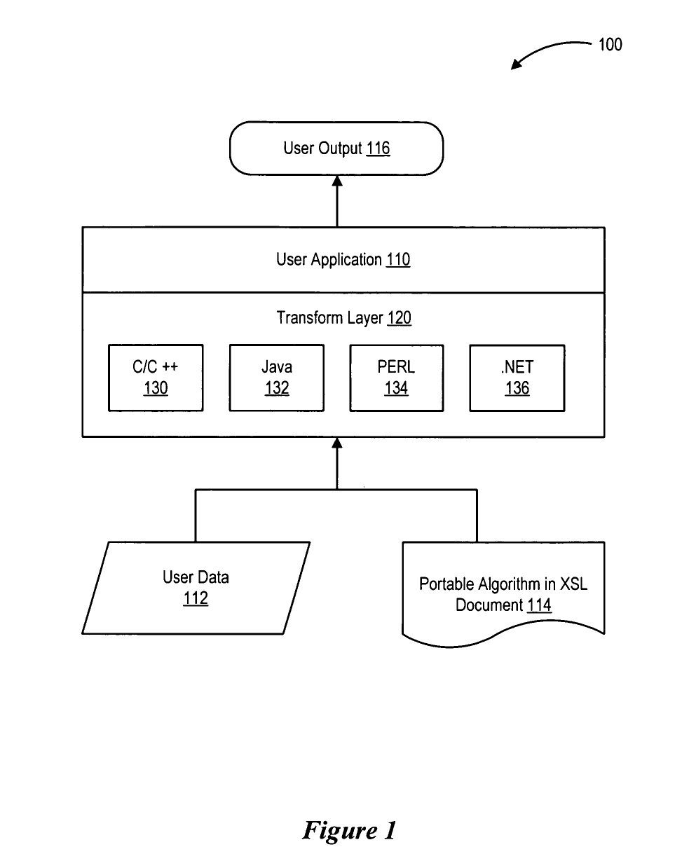

Referring to FIG. 1, a block diagram of an environment 100 which includes a portable algorithm is shown. More specifically, the environment 100 includes a user application 110 which receives user data 112 as well as a portable algorithm that is stored within an XSL document 114 and provides user output 116. The user application includes a transform layer 120.

The user application 110 includes instructions that are compiled from any known programming language. The transform layer 120 includes a compilation portion that corresponds to the known programming language. For example, the transform layer 120 may include a C or C++ compilation portion 130, a Java compilation portion 132, a PERL compilation portion 134 or a .NET compilation portion 136.

Providing the portable algorithm within an XSL document enables portability of the algorithm while removing the dependence of the individuals on a specific programming language for processing. Each entity can write an application that receives inputs and provides outputs in a consistent format regardless of the implementation of the XSL. All consumers of the shared logic are guaranteed the intended behavior of the algorithm and the distributor of the algorithm is the only point of contact for maintenance.

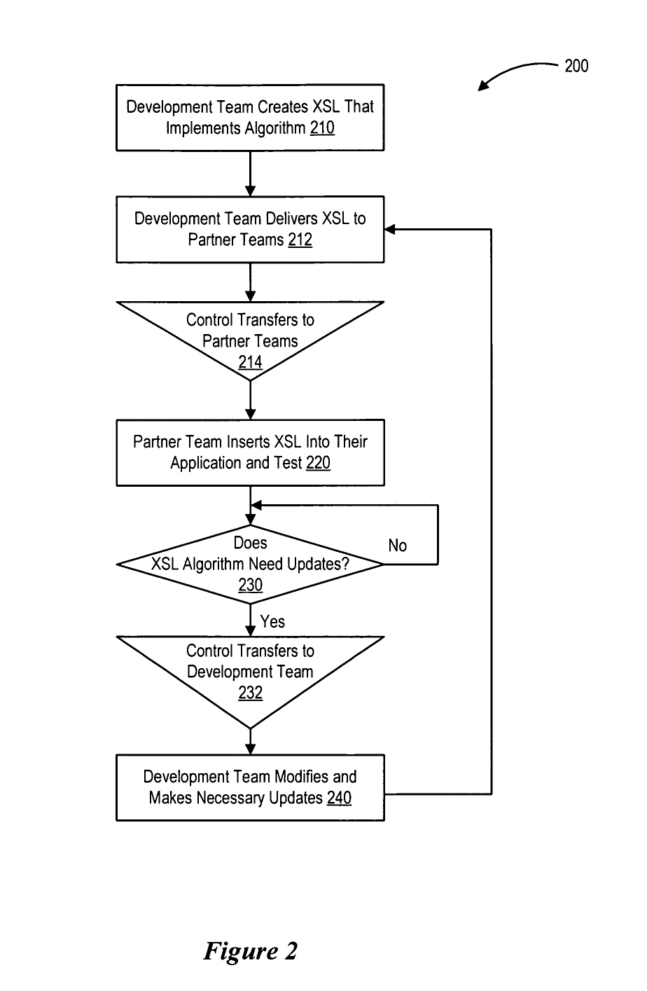

FIG. 2 shows a flow chart of the operation of the method for providing a portable algorithm 200. More specifically, the method begins operation by a development team creating an XSL document that implements the algorithm at step 210. The development team then delivers the XSL document to any partner teams that need to implement the algorithm within an application at step 212. At this point control of the algorithm transfers to each of the partner teams at step 214. Next each partner team inserts the XSL document into their respective application and tests the algorithm at step 220. If any of the partner teams determine that there is a need for an update to the algorithm at step 230, then control transfers back to the algorithm development team at step 232. The development team then modifies the algorithm and makes any necessary updates to the algorithm at step 240. The new or updated algorithm is then delivered to the partner teams at step 212.

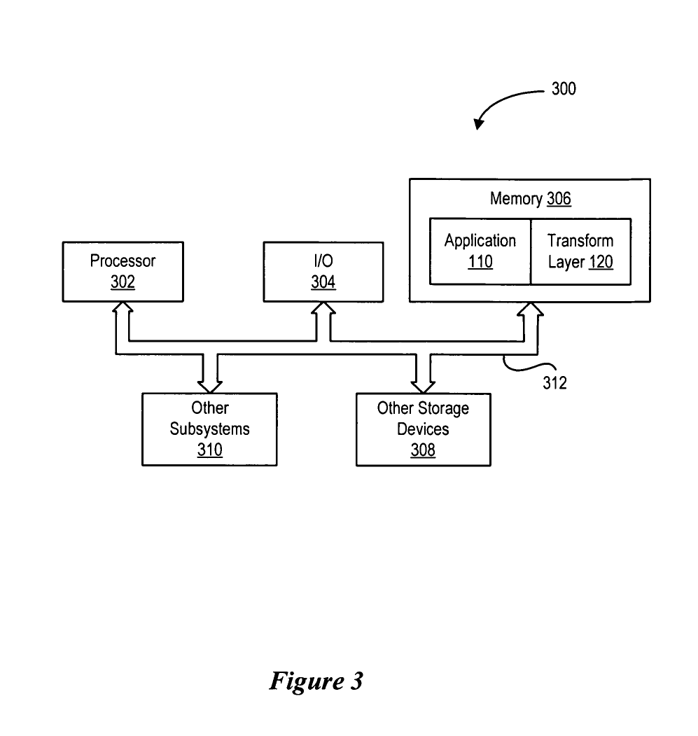

Referring briefly to FIG. 3, a system block diagram of an information handling system 300 is shown. The information handling system 300 includes a processor 302, input/output (I/O) devices 304, such as a display, a keyboard, a mouse, and associated controllers, memory 306, including non-volatile memory such as a hard disk drive and volatile memory such as random access memory (RAM), and other storage devices 308, such as a CD ROM or DVD disk and drive and other memory devices, and various other subsystems 310, all interconnected via one or more buses 312. The user application 110 which includes the transform layer 120 may be stored on the memory 306 and executed by the processor 302. The portable algorithm 114 may be received by the information handling system 300 via either an input/output device 304 or the other storage devices 308.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

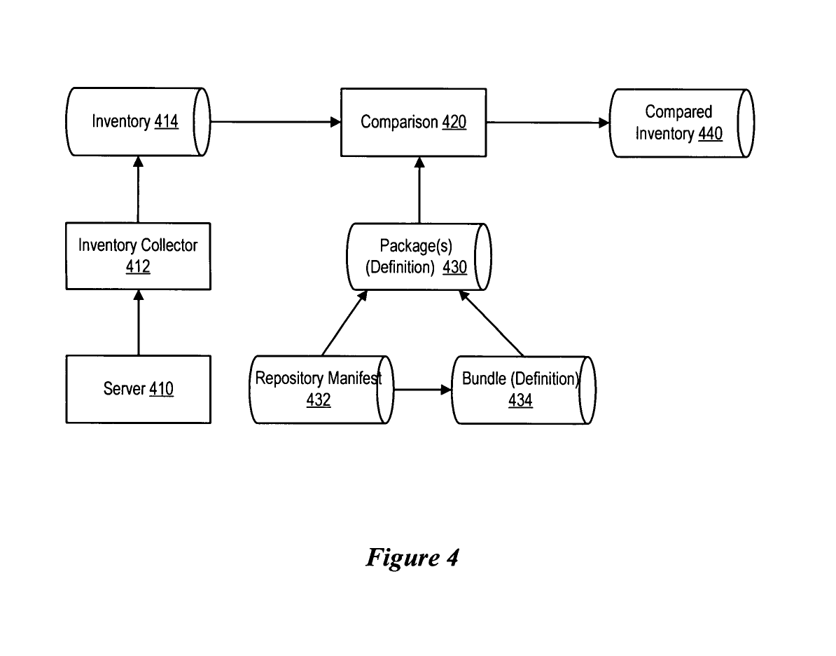

FIG. 4 shows an example of a system 400 which uses the method for providing a portable algorithm. One example of such a system is a system which enables independent software vendors to build change management solutions for an information handling system manufacturer. One function of the system 400 is performing an element comparison between the inventory of a particular system (i.e. the software executing on the system) and an update package of software. The comparison identifies which elements on the system could be updated by the package and how the versions of each of the elements compare.

The system 400 includes a server 410, on which the software executing is executing. An inventory collector 412 generates an inventor 414 of the software that is executing on the server 410. The inventory 414 is provided to a comparison module 420 which also receives as an input the update package 430. The update package includes a repository manifest 432 and a software bundle 434. The comparison module 420 generates a compared inventory document 440.

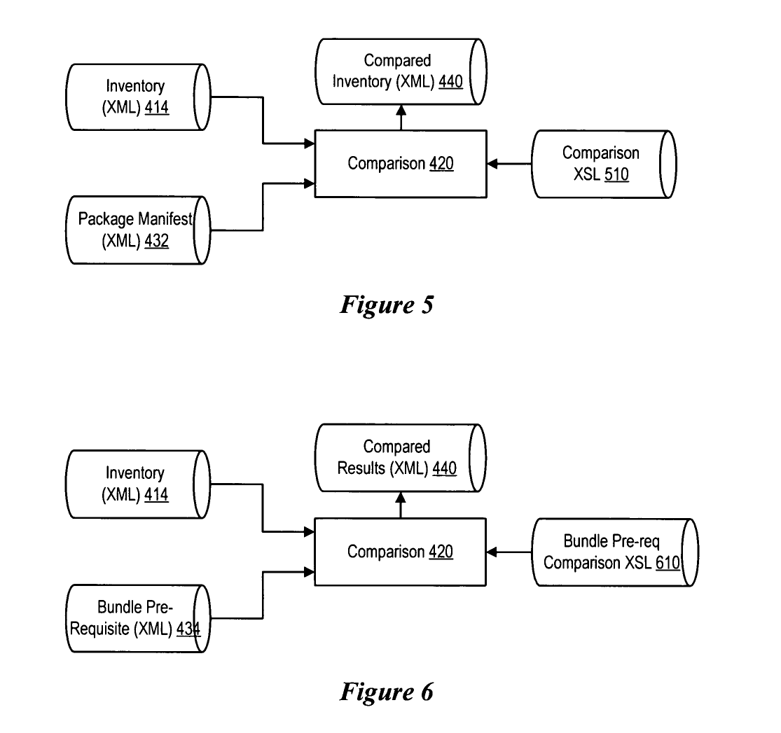

FIG. 5 shows a block diagram of the operation of the example system when performing the comparison function. More specifically, the comparison function locates package nodes from the bundle node and compares each package in the bundle to the devices from the inventory of the system. The algorithm identifies applicable devices and matches the package data. The comparison algorithm performs a plurality of functions including system ID matching between the inventory and the package, operating system match between the inventory and the package, device match between the inventory and the package and application matching between the inventory and the package data. All applications that can be updated by the package are located by the inventory collector 412.

The comparison is performed using a comparison file 512, which conforms to the XSL document standard, and two sets of XML data, the inventory XML data 414 and the package manifest XML data 432.

In operation, the system loads the inventory comparison XSL file, loads the XML based inventory data, loads the XML based package manifest data and transforms the comparison and generates an XML based compared results 440.

FIG. 6 shows another block diagram of the operation of the example system. More specifically, the comparison function locates package nodes from the bundle node and compares each package in the bundle to the devices from the inventory of the system. The algorithm identifies applicable devices and matches the package data. The comparison algorithm performs a plurality of functions including system ID matching between the inventory and the package, operating system match between the inventory and the package, device match between the inventory and the package and application matching between the inventory and the package data. All applications that can be updated by the package are located by the inventory collector 412.

The comparison is performed using a bundle prerequisite comparison file 512, which conforms to the XSL document standard, and two sets of XML data, the inventory XML data 414 and the bundle prerequisite XML data 434.

In operation, the system loads the bundle prerequisite comparison XSL file, loads the XML based inventory data, loads the XML based package bundle prerequisite data and transforms the comparison and generates an XML based compared results 440.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for sharing logic among a plurality of entities comprising:
storing the logic using an extensible stylesheet language (XSL) standard as an XSL logic document
distributing the XSL logic document to a plurality of entities;
importing the XSL logic document into software applications of respective entities of the plurality of entities, the software applications being independent of the XSL logic document, each software application including a transform portion for translating the XSL logic document into a language of the software application.

2. The method of claim 1 wherein:
the logic includes algorithms.

3. The method of claim 1 wherein:
the software applications of the respective entities receive inputs and provide outputs in a format consistent with the XSL document.

4. The method of claim 1 wherein:
the XSL logic document is provided by a single entity and the single entity is the only point of contact for maintenance of the logic.

5. The method of claim 4 wherein:
the single entity is an information handling system manufacturer; and
the XSL logic enables an independent software vendor to build change management solutions

6. The method of claim 1 wherein:
each of the plurality of entities to which the XSL logic document is provided is an independent software vendor; and,
the XSL logic enables the independent software vendor to build change management solutions

7. An apparatus for sharing logic among a plurality of entities comprising:
means for storing the logic using an extensible stylesheet language (XSL) standard as an XSL logic document
means for distributing the XSL logic document to a plurality of entities;
means for importing the XSL logic document into software applications of respective entities of the plurality of entities, the software applications being independent of the XSL logic document, each software application including a transform portion for translating the XSL logic document into a language of the software application.

8. The apparatus of claim 7 wherein:
the logic includes algorithms.

9. The apparatus of claim 7 wherein:
the software applications of the respective entities receive inputs and provide outputs in a format consistent with the XSL document.

10. The apparatus of claim 7 wherein:
the XSL logic document is provided by a single entity and the single entity is the only point of contact for maintenance of the logic.

11. The apparatus of claim 10 wherein:
the single entity is an information handling system manufacturer; and
the XSL logic enables an independent software vendor to build change management solutions

12. The apparatus of claim 7 wherein:
each of the plurality of entities to which the XSL logic document is provided is an independent software vendor; and,
the XSL logic enables the independent software vendor to build change management solutions

13. An information handling system comprising
a processor;
memory coupled to the processor, the memory storing a software application, the software application receiving an XSL logic document, the software application being independent of the XSL logic document, the software application including a transform portion for translating the XSL logic document into a language of the software application.

14. The information handling system of claim 13 wherein:
the XSL logic document defines logic; and,
the logic includes algorithms.

15. The information handling system of claim 13 wherein:
the software application receives inputs and provide outputs in a format consistent with the XSL document.

16. The information handling system of claim 13 wherein:
the XSL logic document is provided by a single entity and the single entity is the only point of contact for maintenance of the logic.

17. The information handling system of claim 13 wherein:
the single entity is an information handling system manufacturer; and
the XSL logic enables an independent software vendor to build change management solutions
